(19) United States
(12) Patent Application Publication
(10) Pub. No.: US 2017/0205254 A1
(43) Pub. Date: Jul. 20, 2017

(54) METHOD AND APPARATUS FOR MEASURING PHYSICAL QUANTITY BASED ON TIME AND WAVELENGTH DIVISION MULTIPLEXING (TWDM)

(71) Applicant: Electronics and Telecommunications Research Institute, Daejeon (KR)

(72) Inventors: Hyoung Jun PARK, Gwangju (KR); Hyun Seo KANG, Gwangju (KR); Keo Sik KIM, Gwangju (KR); Young Sun KIM, Gwangju (KR); Jeong Eun KIM, Gwangju (KR); Ji Hyoung RYU, Jeonju (KR); Young Soon HEO, Gwangju (KR)

(21) Appl. No.: 15/408,260

(22) Filed: Jan. 17, 2017

(30) Foreign Application Priority Data
Jan. 18, 2016 (KR) 10-2016-0005885

(51) Int. Cl. G01D 5/353; G01K 11/32; G01L 1/24; G02F 1/1333

(52) U.S. Cl. CPC G01D 5/35354; G02F 1/133382; G01K 11/3206; G01L 1/246

(57) ABSTRACT

Provided is an apparatus for generating an incident light, the apparatus including an input light generator configured to generate an input light by changing an intensity of an operational signal at intervals of a predetermined period, a filter configured to change a wavelength of the input light through an electrical change, and a light amplifier configured to amplify an intensity of the input light having the changed wavelength to emit an incident light.

### CROSS-REFERENCE TO RELATED APPLICATION(S)

This application claims the priority benefit of Korean Patent Application No. 10-2016-0005885 filed on Jan. 18, 2016, in the Korean Intellectual Property Office, the disclosure of which is incorporated herein by reference for all purposes.

### BACKGROUND

1. Field

One or more example embodiments relate to a method and apparatus for measuring a physical quantity and, more particularly, to a method and apparatus for measuring a physical quantity using an optical fiber grating.

2. Description of Related Art

In terms of implementing a physical quantity measuring apparatus, simplicity of structure and low costs may be significant factors to be achieved as well as a high accuracy on measuring a physical quantity. A scheme of configuring a sensor using an optical fiber grating may be one of schemes for implementing the physical quantity measuring apparatus with reduced costs. The optical fiber grating may be more precise and less susceptible for noise when compared to, for example, a temperature sensor, a strain gauge, and an accelerometer. Also, due to an ease of integration, the optical fiber grating may be readily configured in a semi-distributed grating array. Accordingly, a plurality of optical fiber gratings may be configured in a single optical fiber line such that a simple and efficient physical quantity measuring apparatus is implemented.

### SUMMARY

An aspect provides a method and apparatus for configuring a light source by integrating a wavelength variable filter and a light amplifier in a single package so as to be in a simple structure to achieve a simple structure and reduce costs for the light source, which may be suitable for mass production.

Another aspect also provides a method and apparatus for simultaneously realizing a time wavelength division multiplexing (TWDM) technique by periodically change a trigger signal of a wavelength variable filter.

According to an aspect, there is provided an apparatus for generating an incident light, the apparatus including an input light generator configured to generate an input light by changing an intensity of an operational signal at intervals of a predetermined period, a filter configured to change a wavelength of the input light through an electrical change, and a light amplifier configured to amplify an intensity of the input light having the changed wavelength to emit an incident light.

The input light generator may be configured to change a center wavelength of the input light by changing the intensity of the operational signal at intervals of the predetermined period.

The filter may be configured to change a refractive index of the filter through the electrical change and change the wavelength of the input light based on the changed refraction index.

The apparatus may further include a lens configured to collect the input light having the changed wavelength and transfer the input light to the light amplifier.

The apparatus may further include a cooler disposed adjacent to the filter to maintain a constant temperature of the filter.

According to another aspect, there is also provided an apparatus for measuring a physical quantity, the apparatus including a light source configured to emit an incident light of which a center wavelength is changed at intervals of a predetermined period and a wavelength is changed through an electrical change in each period, a sensor configured to reflect a portion of the incident light; the portion corresponding to a predetermined wavelength of the incident light, a signal converter configured to convert the reflected portion of the incident light into an electrical signal, and a data processor configured to measure a physical quantity of the electrical signal.

The light source may include an input light generator configured to change an intensity of an operational signal at intervals of the predetermined period, a filter configured to change a wavelength of an input light through the electrical change, and a light amplifier configured to amplify an intensity of the input light having the changed wavelength and emit the incident light, and the wavelength of the incident light may be changed in response to a change in the wavelength of the input light.

The input light generator may be configured to change the intensity of the operational signal at intervals of the predetermined period and change a center wavelength of the input light to change the center wavelength of the incident light.

The sensor may include an optical fiber grating configured to reflect a portion of the incident light, the portion having a wavelength satisfying a grating condition.

The data processor may be configured to periodically synchronize electrical signals to measure the physical quantity.

The apparatus may further include a corrector configured to correct an error in the center wavelength.

The apparatus may further include a light circulator configured to change a direction of the incident light received from the light source to a direction toward the filter, and change a direction of the reflected portion of the incident light received from the filter to a direction toward the signal converter.

According to still another aspect, there is also provided a method of generating an incident light, the method including generating an input light by changing an intensity of an operational signal at intervals of a predetermined period, changing a wavelength of the input light through an electrical change, and amplifying an intensity of the input light having the changed wavelength and radiating an incident light.

According to yet another aspect, there is also provided a method of measuring a physical quantity, the method including emitting an incident light of which a center wavelength is changed at intervals of a predetermined period and a wavelength is changed through an electrical change in each period, reflecting a portion of the incident light; the portion corresponding to a predetermined wavelength of the incident light, converting the reflected portion of the incident light into an electrical signal, and measuring a physical quantity of the electrical signal.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an apparatus for measuring a physical quantity based on a time and wavelength division multiplexing (TWDM) according to an example embodiment;

FIG. 2 is a diagram illustrating a light source of a TWDM-based physical quantity measuring apparatus according to an example embodiment;

FIG. 3 is a graph illustrating a spectrum of a light penetrating a filter in response to a trigger signal according to an example embodiment;

FIG. 4 is a graph illustrating a change in a center wavelength of a light reflected from an optic fiber grating corresponding to a spectrum of a light having a center wavelength of which a location changes over time according to an example embodiment;

FIG. 5 is a flowchart illustrating a TWDM-based physical quantity measuring method according to an example embodiment; and

FIG. 6 is a flowchart illustrating a TWDM-based incident light generating method according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Terms such as first, second, A, B, (a), (b), and the like may be used herein to describe components. Each of these terminologies is not used to define an essence, order or sequence of a corresponding component but used merely to distinguish the corresponding component from other component(s). For example, a first component may be referred to a second component, and similarly the second component may also be referred to as the first component.

It should be noted that if it is described in the specification that one component is “connected,” “coupled,” or “joined” to another component, a third component may be “connected,” “coupled,” and “joined” between the first and second components, although the first component may be directly connected, coupled or joined to the second component. In addition, it should be noted that if it is described in the specification that one component is “directly connected” or “directly joined” to another component, a third component may not be present therebetween. Likewise, expressions, for example, “between” and “immediately between” and “adjacent to” and “immediately adjacent to” may also be construed as described in the foregoing.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

The following example embodiments may be applied to identify a movement of an object in a moving image and determine a type of the identified movement.

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings.

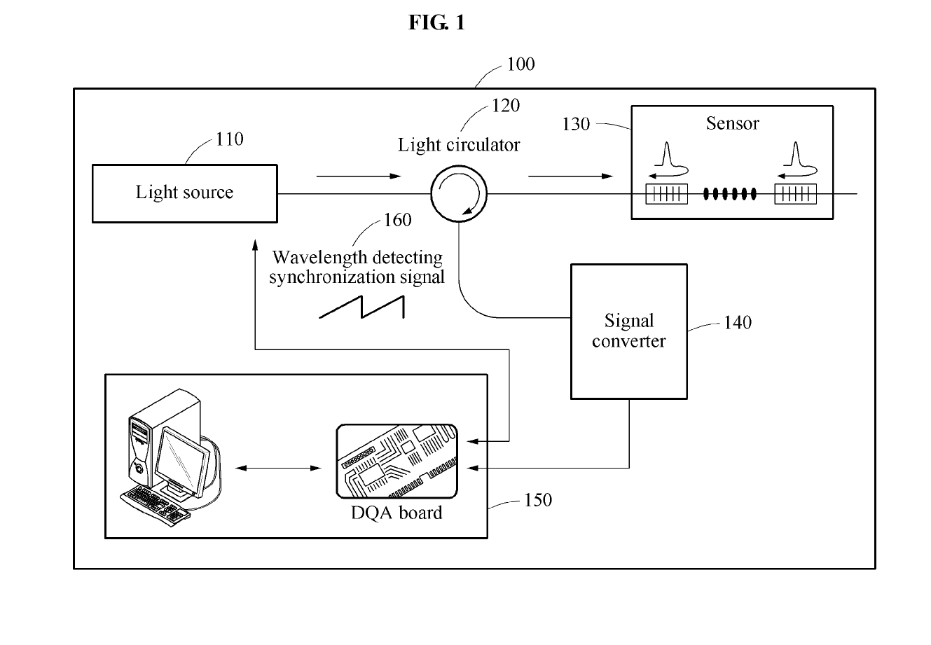

FIG. 1 is a diagram illustrating an apparatus for measuring a physical quantity based on a time and wavelength division multiplexing (TWDM) according to an example embodiment. Hereinafter, the apparatus for measuring a physical quantity based on a TWDM may also be referred to as, for example, a physical quantity measuring apparatus.

A physical quantity measuring apparatus 100 may include a light source 110, a light circulator 120, a sensor 130, a signal converter 140, and a data processor 150. The physical quantity measuring apparatus 100 may generate an incident light through the light source 110 based on the TWDM and emit the incident light to the light circulator 120. The light circulator 120 may change a direction of the incident light and transfer the incident light to the sensor 130. The sensor 130 may transfer a reflection light obtained by applying a desired physical quantity to the incident light to the light circulator 120. The light circulator 120 may change a direction of the reflection light and transfer the reflection light to the signal converter 140. The signal converter 140 may convert the reflection light into an electrical signal. The data processor 150 may measure a physical quantity obtained by detecting from the electrical signal. A light emitted from the light source 110 may be referred to as the incident light.

The light source 110 may change a wavelength of an input light generated by changing an intensity of an operational signal at intervals of a predetermined period. Also, the light source 110 may amplify an intensity of the input light having the changed wavelength to generate the incident light and emit the generated incident light. Hereinafter, the operational signal may also be referred to as, for example, a trigger signal. Also, the light source 110 may be referred to as a light source. The input light may indicate a light processed internal to the light source 110. In contrast, the incident light may correspond to an output of the light source 110. The operational signal may also be referred to as, for example, a wavelength detecting synchronization signal 160.

The sensor 130 may include a distributed sensor. The distributed sensor may be a sensor using a plurality of optical fiber gratings. In general, a wavelength division multiplexing (WDM) technique may be used to use the distributed sensor. Using the WDM technique, an optical fiber array may be easily demodulated. A maximum number of optical fiber gratings to be accepted in the WDM technique may be determined based on a spectrum bandwidth of an input light and a dynamic wavelength range of an optical grating sensor. When compared to a time division multiplexing (TDM) technique, an amount of signal processing time may be reduced in the WDM technique. Hereinafter, the optical fiber grating may also be referred to as, for example, an optical fiber grating sensor.

Dissimilarly to the WDM technique, the TDM technique may be a method of transmitting an incident light modulated in a form of pulse to the distributed sensor and measuring a signal obtained based on the incident light reflected from the optical fiber included in the distributed sensor. A physical quantity may be measured based on a delay time between reflected lights detected in response to a reflection from each optical fiber grating.

Since the optical grating having the same Bragg wavelength without restrictions on the spectrum bandwidth of the incident light is used in the TDM technique, the plurality of optical fiber gratings may be multiplexed into an optical fiber as an optical fiber grating array. For example, using the TDM technique, at least 100 optical fiber gratings may be multiplexed into an optical fiber as an optical fiber grating array. Due to a delay time, an amount of signal processing time may increase in the TDM technique in comparison to the WDM technique.

The light source 110 may be provided for implementing a light source used to a wavelength of a reflected light reflected from the optical fiber grating. The light source 110 may be configured by integrating a filter 210 and a light amplifier in a single package. Thus, the light source 110 may be provided in a simple structure, which may reduce costs for the light source 110 and be suitable for mass production. Also, the light source 110 may periodically change a trigger signal of the filter 210 to simultaneously realize the TWDM. The physical quantity measuring apparatus 100 may use a TWDM-based incident light to analyze a reflected light reflected from the optical fiber grating sensor included in the sensor 130 and measure various types of physical quantities including a high-velocity physical quantity such as a voltage and a vibration as well as a low-velocity physical quantity such as a temperature and a strain. Concisely, the TWDM-based light source may be applied to provide a semi-distributed sensor device with relatively low costs.

The light circulator 120 may change a route of the incident light. Specifically, the light circulator 120 may change a direction of the incident light received from the light source 110 to a direction to the sensor 130 and change a direction of the reflected light received from the sensor 130 to a direction to the signal converter 140. Here, the reflected light may be the incident light reflected and received from the filter 210.

For example, the light circulator 120 may include a passive non-reciprocal device provided in a circular structure to receive a signal through one terminal and output the signal to a directly neighboring terminal. The passive non-reciprocal device may include a configuration in which three ports 1, 2, and 3 are circularly arranged, for example, a 3-port passive element. Here, a connection in a forward direction, for example, a connection from the port 1 to the port 2, a connection from the port 2 to the port 3, and a connection from the port 3 to the port 1 may be allowed. However, a connection in a reverse direction, for example, a connection from the port 1 to the port 3, a connection from the port 3 to the port 2, and a connection from the port 2 to the port 1 may not be allowed.

The sensor 130 may reflect a portion corresponding to a predetermined wavelength of the incident light. Specifically, the sensor 130 may include the optical fiber grating and reflect a wavelength satisfying a grating condition of the optical fiber grating. Here, a plurality of wavelength satisfying the grating condition may resonate and thus, may be referred to as, for example, a resonant wavelength. The plurality of wavelength may be obtained in response to a reflection from the optical fiber grating and thus, may also be referred to as, for example, the reflected light.

An optical fiber grating may be more precise and less susceptible for noise when compared to, for example, a temperature sensor, a strain gauge, and an accelerometer. Also, the optical fiber grating may be readily configured in a semi-distributed grating array. Accordingly, a plurality of optical fiber gratings may be configured in a single optical fiber line, which allows a configuration of a simple and efficient sensor. In practice, hundreds of optical fiber gratings may be provided in a single piece of optical fiber. The optical fiber grating may be spaced apart from one another by a few millimeters (mm) or a few kilometers (km). Microstructures of the optical fiber gratings may be appropriately provided in a package so as to have susceptibility for a parameter, for example, a pressure, an acceleration, and a displacement as well as a temperature and a strain.

For example, the sensor 130 may include a fiber Bragg grating (FBG). The FBG may be in a microstructure of which a length is within a few millimeters in general. A beam may be radiated to a standard single-mode optical fiber having such microstructure such that a grating is provided on an optical fiber core. Specifically, a phase mask may be disposed on the optical fiber and an ultraviolet (UV) laser beam may be radiated to the optical fiber in a transverse direction. Through this, an indirect pattern, that is, a grating array may be formed on the optical fiber core along the optical fiber. By applying a spatial periodic modulation based on a change in refractive index of the optical fiber, the optical fiber may be changed to be in a resonance structure. Through this, a permanent physical property change may occur in a silica matrix.

The FBG in the resonance structure may be a wavelength selective mirror. For example, the FBG may reflect a predetermined wavelength. In this example, the predetermined wavelength may be a wavelength satisfying a Bragg grating condition. Also, the FBG may function as a narrow band filter through which the predetermined wavelength passes. Specifically, when an input light of a wide band is radiated to the FBG, a portion corresponding to a wavelength included in a narrow band, that is, the Bragg band may be reflected and a portion corresponding to a remaining wavelength may be transmitted to a subsequent FBG along the optical fiber without light loss. Since the FBG is in a symmetric structure, the input light corresponding to the Bragg band may be reflected by the FBG irrespective of a radiated direction.

A period of the microstructure of the FBG may be changed based on a change in physical quantity applied to the optical fiber. The Bragg band may be determined based on the period of the microstructure and the refractive index. Thus, the input light satisfying the Bragg band may be differently selected based on the change in physical quantity. That is, a wavelength of a reflected light may be changed based on the change in the physical quantity. The data processor 150 may measure the change in physical change based on a change in the wavelength of the reflected light.

For example, the FBG may be susceptible for the temperature. When a thermal expansion occurs in the microstructure in response to a change in temperature, the period of the microstructure may change, which may lead to the change in wavelength of the reflected light. Thus, the data processor 150 may measure the change in temperature based on the change in the wavelength of the reflected light. When an intensity of strain applied to the optical fiber is changed, the period of the microstructure may also be changed. Thus, the data processor 150 may measure a change in strain based on the change in wavelength of the reflected light.

The signal converter 140 may convert an optical signal of the reflected light into an electrical signal. For example, the light circulator 120 may change a direction of the reflected light received from the sensor 130 to a direction to the signal converter 140, and the signal converter 140 may receive the reflected light. The signal converter 140 may convert the reflected light into an electrical signal using a light detector and a noise filter.

The light detector may be, for example, a photodiode. The photodiode may detect the reflected light, generate a current corresponding to the reflected light, and convert the reflected light into the electrical signal. In this example, noise component occurring in a circuit or a wire may be removed by the noise filter.

The data processor 150 may extract data from the electrical signal, analyze the data, and provide a measured physical quantity to a user. The data processor 150 may include a digital signal converter configured to convert an analog type electrical signal into a digital signal and a physical quantity measurer configured to obtain a physical quantity from the digital signal.

The digital signal convert may function as an interface between the physical quantity measurer and the signal converter 140. In other words, the digital signal convert may convert the electrical signal into the digital signal to be decrypted by the physical quantity measurer. The digital signal converter may include, for example, a signal conditioning circuit, an analog-to-digital converter (ADC), and a computer bus. Also, the digital signal converter may include a measuring device and a process automating function. A digital-to-analog converter (DAC) may output an analog signal and a digital input/output (I/O) line input and output digital signal. A counter/timer may count and generate a digital pulse. The DAC may include, for example, a data acquisition (DAQ) board.

Although nor shown, the physical quantity measuring apparatus 100 may include a corrector configured to compensate for an error in a center wavelength of an incident light of which a wavelength is changed. The corrector may include an optical element, for example, a reference optical fiber grating and a wavelength locker.

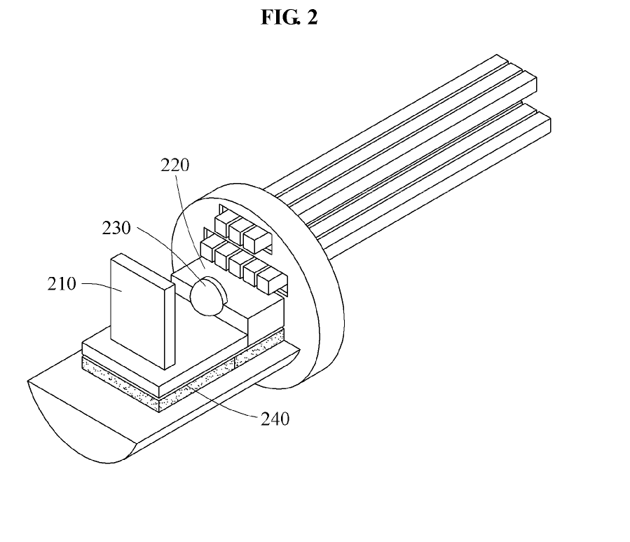

FIG. 2 is a diagram illustrating a light source of a TWDM-based physical quantity measuring apparatus according to an example embodiment.

The light source 110 may include an input light generator, the filter 210, a light amplifier 220, a lens 230, and a cooler 240. The input light generator may transfer an input light generated by changing an intensity of an operation signal to the filter 210. The filter 210 may change a wavelength of the input light, and then transfer the input light to the lens 230. The lens 230 may perform integration on the input light having the changed wavelength, and then transfer the input light to the light amplifier 220. The light amplifier 220 may amplify an intensity of the input light having the changed wavelength, and then emit an incident light to the light circulator 120.

The input light generator may generate the input light by changing the intensity of the operational signal at intervals of a predetermined period and transfer the input light to the filter 210. In response to the intensity of the operational signal changing at intervals of the predetermined period, a center wavelength of the input light incident upon the filter 210 may move at a predetermined interval. Accordingly, a TWDM-based light source may be formed through a periodical change in the intensity of the operational signal and an electrical change applied to a wavelength variable filter, for example, the filter 210.

The filter 210 may include a wavelength variable filter. The wavelength variable filter may indicate, for example, a filter configured to change a wavelength of a light incident upon the filter. The wavelength variable filter may include, for example, a liquid crystal (LC) tunable filter. The LC tunable filter may change a refractive index of a liquid crystal through an electrical change applied to the LC tunable filter. Based on the changed refractive index, the liquid crystal may change a wavelength of a light incident upon the LC tunable filter.

The light amplifier 220 may amplify an intensity of the input light having the changed wavelength. A light amplifier may amplify a light through a reflection. The light amplifier may include, for example, a reflective semiconductor optical amplifier (RSOA).

The lens 230 may perform integration on the input light having the changed wavelength and transfer the input light to the light amplifier 220. The cooler 240 may alleviate a change in the filter 210 based on a change in temperature. Specifically, since the LC tunable filter has a characteristic that the refractive index of the liquid crystal changes based on the change in temperature in general, the cooler 240 may maintain a temperature of the LC tunable filter to be within a predetermined range. The cooler 240 may include a heat pump. The cooler 240 may absorb a heat from a low-temperature heat source and transmit the heat to a high-temperature heat source. The cooler 240 may include, for example, a thermoelectric cooler (TEC). Here, the TEC may also be referred to as, for example, a Peltier Module, and a thermoelectric module (TEM).

Elements of the light source 110 may be integrated into a predetermined package. For example, elements of the light source 110 may be integrated into a transistor outline (TO)-can package. In consideration of a heat dissipation characteristic of the TO-can package, the elements of the light source 110 including the filter 210 may be integrated in a header part of the TO-can package to reduce a temperature dependency of the LC tunable filter as illustrated in FIG. 2. In FIG. 2, a bar-shaped element in a right portion of the TO-can package may function as a lead pin configured to fix the TO-can to a substrate.

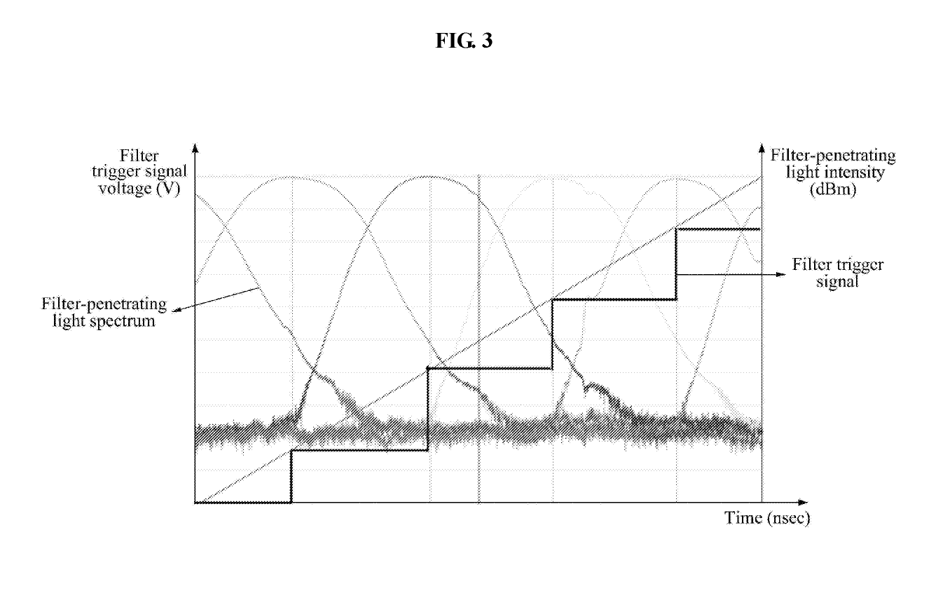

FIG. 3 is a graph illustrating a spectrum of a light penetrating a filter in response to a trigger signal according to an example embodiment.

In a graph of FIG. 3, an intensity of an input light penetrating the filter 210 over time is represented by a sine wave and a voltage of an operational signal applied to the filter 210 over time is represented by a stepped square wave.

A voltage of the operational signal may increase by a predetermined magnitude of voltage at intervals of a predetermined period. Based on an increased voltage, a refractive index of a liquid crystal of the filter 210 may be changed by a predetermined amount of refractive index. Based on the changed refractive index, a center wavelength of the input light penetrating the filter 210 may move by a predetermined interval. In this instance, a time division multiplexing may be performed and a reference of time division may be an increasing time of the operational signal.

In terms of an LC tunable filter, a range of wavelength of the input light penetrating the filter 210 may be adjusted based on a thickness of a liquid crystal and a characteristic of the liquid crystal. Also, a range of wavelength of an optical fiber grating included in the sensor 130 may be determined based on the range of wavelength of the input light penetrating the filter 210. In terms of an FBG, a range of wavelength may correspond to a Bragg band.

The data processor 150 may detect a change in a wavelength of a reflected light from an electrical signal received from the signal converter 140. The change in the wavelength of the reflected light may include a change in a physical quantity detected by the sensor 130 and thus, the data processor 150 may measure the physical quantity based on the change in the wavelength of the reflected light. In this example, the operational signal of the light source 110 may be used to synchronize the wavelength of the reflected light and the wavelength of the input light. That is, a reference of time division of the input light may be used for synchronization.

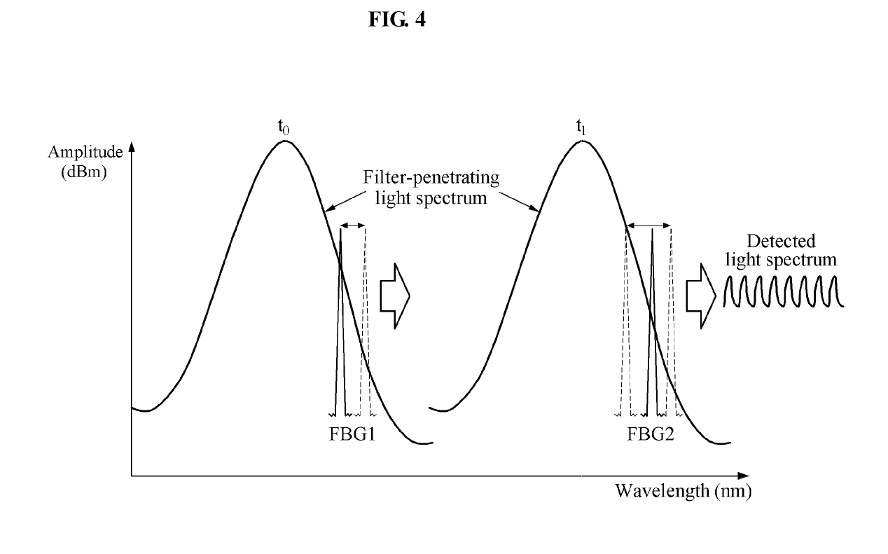

FIG. 4 is a graph illustrating a change in a center wavelength of a light reflected from an optic fiber grating corresponding to a spectrum of a light having a center wavelength of which a location changes over time according to an example embodiment.

The data processor 150 of FIG. 1 may detect a change in a wavelength of a reflected light from an electrical signal received from the signal converter 140. The change in the wavelength may include a change in a physical quantity detected by the sensor 130. Thus, the data processor 150 may measure the physical quantity based on the change in the wavelength of the reflected light. Specifically, an intensity of the reflected light may be detected from the change in the wavelength, and the physical quantity may be measured based on the intensity of the reflected light.

An FBG may be formed to be susceptible for a predetermined physical quantity. In response to a change in the physical quantity, a period of a microstructure of the FBG may be changed. Also, a Bragg band corresponding to the reflected light may be changed in response thereto. Accordingly, the physical quantity may be measured based on the change in the reflected light.

Spectrums of an input light penetrating the filter 210 in an example of FIG. 2 may correspond to operational signals corresponding to a time t₀ and a time t₁ with reference to FIG. 4. In an example of FIG. 4, the sensor 130 may include the FBG. Also, an FBG1 may be a spectrum of a reflected light corresponding to a time t₀, and an FBG2 may be a spectrum of a reflected light corresponding to a time t₁. In a graph of FIG. 4, a horizontal axis represents a wavelength and a vertical axis represents an amplitude. Thus, a light penetrating a filter and a change in a wavelength of a reflected light may be acquired with reference to FIG. 4. Here, the light penetrating the filter may indicate an input light obtained after penetrating the filter in the light source 110 of FIG. 1.

The data processor 150 may detect an intensity of the reflected light from a change in a wavelength of the FBG1 at the time t₀. Also, the data processor 150 may detect an intensity of the reflected light from a change in a wavelength of the FBG2 at the time t₁. In this example, the time t₀ and the time t₁ may correspond to increasing times in predetermined neighboring periods of an operational signal of the light source 110. Also, the data processor 150 may synchronize the spectrum of the reflected light with the input light penetrating the filter using the operational signal. In FIG. 4, the detected spectrum of the light may correspond to the detected intensity of the reflected light.

For example, the data processor 150 may convert, into a change in an intensity of light, a change in a wavelength of an optical fiber grating sensor present in predetermined location and range at a gradient of the input light penetrating the filter. Since a WDM and a TDM are realized by the light source 110, the data processor 150 may easily detect a change in a low-velocity physical quantity such as a change in a temperature and a change in a high-velocity physical quantity such as a vibration or an impulse from the change in the wavelength of the reflected light.

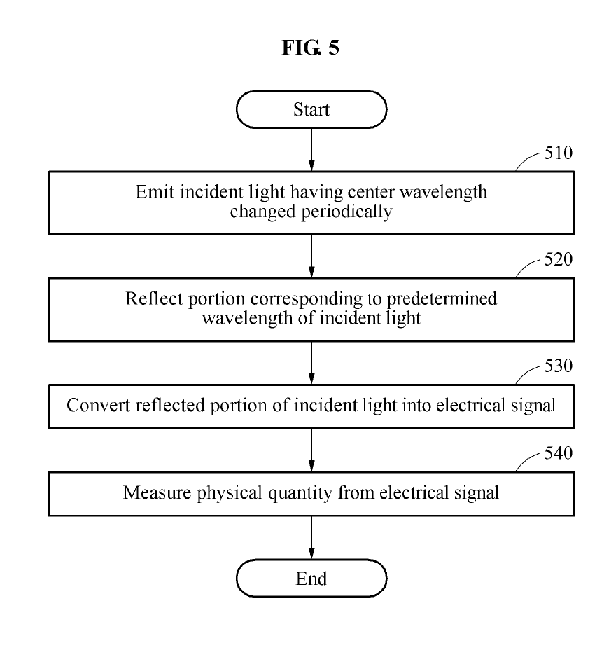

FIG. 5 is a flowchart illustrating a TWDM-based physical quantity measuring method according to an example embodiment.

In operation 510, the physical quantity measuring apparatus 100 of FIG. 1 may emit an incident light having a center wavelength changed at intervals of a predetermined period and a wavelength changed through an electric change in each period. Specifically, the physical quantity measuring apparatus 100 may periodically change a trigger signal of the filter 210 of FIG. 2 to simultaneously realize a TWDM. The physical quantity measuring apparatus 100 may use a TWDM-based incident light to analyze a reflected light reflected from an optical fiber grating sensor included in the sensor 130. Through this, the physical quantity measuring apparatus 100 may measure various types of physical quantities including a high-velocity physical quantity such as a voltage and a vibration as well as a low-voltage physical quantity such as a temperature and a strain.

In operation 520, the physical quantity measuring apparatus 100 may reflect a portion corresponding to a predetermined wavelength of the incident light. Specifically, the sensor 130 of FIG. 1 may include an optical fiber grating and reflect a wavelength satisfying a grating condition of the optical fiber grating. A period of a microstructure of an optical fiber Bragg grating may be changed based on a change in a physical quantity applied to an optical fiber. A Bragg bandwidth may be determined based on the period of the microstructure and a refractive index of a core and thus, the input light satisfying a Bragg band may be selected differently based on a change in the physical change. Concisely, a wavelength of the reflected light may be changed based on the change in the physical quantity.

In operation 530, the physical quantity measuring apparatus 100 may convert the reflected portion of the incident light into an electrical signal. For example, the physical quantity measuring apparatus 100 may perform a photoelectrical conversion on the reflected light to convert an optical signal into an electrical signal which is a form to be analyzed by the data processor 150 of FIG. 1.

In operation 540, the physical quantity measuring apparatus 100 may measure a physical quantity from the electrical signal. Specifically, the physical quantity measuring apparatus 100 may convert the electrical signal into a digital signal to decrypt the electrical signal and measure a physical quantity of the digital signal. In this instance, the physical quantity measuring apparatus 100 may detect an intensity of the reflected light based on a change in the wavelength of the reflected light and measure the physical quantity based on the intensity of the reflected light.

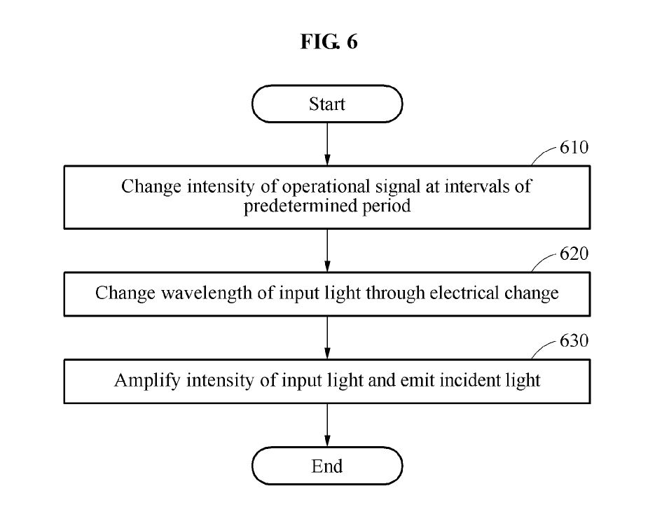

FIG. 6 is a flowchart illustrating a TWDM-based incident light generating method according to an example embodiment.

In operation 610, the light source 110 of FIG. 1 may change an intensity of an operational signal at intervals of a predetermined period to generate an input light. Specifically, in response to a change in the intensity of the operational signal at intervals of a predetermined period, a center wavelength of the input light incident upon the filter 210 of FIG. 2 may move at intervals of the predetermined period. Thus, a TWDM-based light source may be formed through a periodical change in the intensity of the operational signal and an electrical change applied to a wavelength variable sensor, for example, the filter 210.

In operation 620, the light source 110 may change a wavelength of the input light through the electrical change. Specifically, the light source 110 may include a wavelength variable filter, for example, an LC tunable filter. The LC tunable filter may change a refractive index of a liquid crystal through an electrical change applied to the LC tunable filter such that the liquid crystal changes a wavelength of a light incident upon the LC tunable filter based on the changed refractive index.

In operation 630, the light source 110 may amplify an intensity of the input light having the changed wavelength and emit an incident light. Specifically, the light source 110 may amplify the input light through a reflection.

According to an example embodiment, it is possible to provide a light source by integrating a wavelength variable filter and a light amplifier in a single package so as to be in a simple structure to achieve a simple structure and reduce costs for the light source, which may be suitable for mass production.

According to another example embodiment, it is possible to simultaneously realize the TWDM technique by periodically change a trigger signal of a wavelength variable filter.

The components described in the exemplary embodiments of the present invention may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for generating an incident light, the apparatus comprising:
an input light generator configured to generate an input light by changing an intensity of an operational signal at intervals of a predetermined period;
a filter configured to change a wavelength of the input light through an electrical change; and
a light amplifier configured to amplify an intensity of the input light having the changed wavelength to emit an incident light.

2. The apparatus of claim 1, wherein the input light generator is configured to change a center wavelength of the input light by changing the intensity of the operational signal at intervals of the predetermined period.

3. The apparatus of claim 1, wherein the filter is configured to change a refractive index of the filter through the electrical change and change the wavelength of the input light based on the changed refraction index.

4. The apparatus of claim 1, further comprising:
a lens configured to collect the input light having the changed wavelength and transfer the input light to the light amplifier.

5. The apparatus of claim 1, further comprising:
a cooler disposed adjacent to the filter to maintain a constant temperature of the filter.

6. An apparatus for measuring a physical quantity, the apparatus comprising:
a light source configured to emit an incident light of which a center wavelength is changed at intervals of a predetermined period and a wavelength is changed through an electrical change in each period;
a sensor configured to reflect a portion of the incident light; the portion corresponding to a predetermined wavelength;
a signal converter configured to convert the reflected portion of the incident light into an electrical signal; and
a data processor configured to measure a physical quantity of the electrical signal.

7. The apparatus of claim 6, wherein the light source includes:
an input light generator configured to change an intensity of an operational signal at intervals of the predetermined period;
a filter configured to change a wavelength of an input light through the electrical change; and
a light amplifier configured to amplify an intensity of the input light having the changed wavelength and emit the incident light, and
wherein the wavelength of the incident light is changed in response to a change in the wavelength of the input light.

8. The apparatus of claim 7, wherein the input light generator is configured to change the intensity of the operational signal at intervals of the predetermined period and change a center wavelength of the input light to change the center wavelength of the incident light.

9. The apparatus of claim 6, wherein the sensor includes an optical fiber grating configured to reflect a portion of the incident light, the portion having a wavelength satisfying a grating condition.

10. The apparatus of claim 6, wherein the data processor is configured to periodically synchronize electrical signals to measure the physical quantity.

11. The apparatus of claim 6, further comprising:
a corrector configured to correct an error in the center wavelength.

12. The apparatus of claim 6, further comprising:
a light circulator configured to change a direction of the incident light received from the light source to a direction toward the filter, and change a direction of the reflected portion of the incident light received from the filter to a direction toward the signal converter.

13. A method of generating an incident light, the method comprising:
generating an input light by changing an intensity of an operational signal at intervals of a predetermined period;
changing a wavelength of the input light through an electrical change; and
amplifying an intensity of the input light having the changed wavelength and radiating an incident light.
